(19) United States
(12) Patent Application Publication
(10) Pub. No.: US 2026/0247515 A1
(43) Pub. Date: Aug. 20, 2026

(54) CURTAIN-TYPE LED LAMP WITHOUT ARRANGING CIRCUIT MODULE ON MAIN LINE

(71) Applicant: Shangyou Jiayi Lighting Product Co., LTD., Ganzhou (CN)

(72) Inventor: Yaowen He, Ganzhou (CN)

(21) Appl. No.: 19/250,693

(22) Filed: Jun. 26, 2025

(30) Foreign Application Priority Data
Feb. 20, 2025 (CN) 2025101918343

(51) Int. Cl. H05B 47/18; H05B 45/46

(52) U.S. Cl. CPC H05B 47/18; H05B 45/46

(57) ABSTRACT

The present disclosure discloses a curtain-type LED lamp without arranging a circuit module on a main line, including: a main line of a curtain-type LED lamp arranged in a first direction, and first to n-th (a total of n) LED light strings arranged in parallel to each other in a second direction different from the first direction to configure the curtain-type LED lamp; wherein, each LED light string includes a plurality of LED emitters and an address signal processing device for the respective LED light string; each address signal processing device includes a processing unit, the processing unit is configured to perform address coding on the address of at least one LED emitter in the LED light string to which the address signal processing device belongs, so as to enable the respective LED emitters in the LED light string to work normally on the premise of arranging no circuit module.

### CROSS-REFERENCE TO RELATED APPLICATION

This application claims priority from the Chinese patent application 2025101918343 filed Feb. 20, 2025, the content of which is incorporated herein in the entirety by reference.

### TECHNICAL FIELD

The present disclosure relates to a curtain-type LED lamp, and in particular, to a curtain-type LED lamp without arranging a circuit module on a main line.

### BACKGROUND

Taking an existing point-controlled RGB curtain lamp as an example, besides a plurality of parallel light strings, it also includes a main line on which a decoding board must be arranged. There are mainly the following problems:
firstly, for light strings that adopt signal parallel connection, they are limited by the number of lights and the wiring materials, meaning that the number of lights cannot be too many, and the distance cannot be too far, otherwise the signal will be affected;
secondly, for light strings that adopt signal series connection, the signal is transmitted from one light to the next. Due to the curtain-like shape, the signal from the last light of the first light string needs to be transmitted to the first light of the second light string. This requires an additional signal return wire, increasing the wiring cost. Furthermore, in a series connection, if one light is damaged, all the lights following it will fail to receive the signal, causing them to fail to illuminate; and
thirdly, once the decoding board on the main line fails, all the light strings will fail to work normally. Moreover, replacing the decoding board involves the need to have prior knowledge of the address of each light on all the light strings in order to normally send signals to each light and enable them to work normally.

Therefore, there is an urgent need in the field to address the aforementioned technical problems in an innovative manner.

### SUMMARY

In order to solve the above technical problems, the present disclosure provides a curtain-type LED lamp without arranging a circuit module on a main line, including:
a main line of a curtain-type LED lamp arranged in a first direction, and first to n-th (a total of n) LED light strings arranged in parallel to each other in a second direction different from the first direction to configure the curtain-type LED lamp, n being a natural number greater than 1, wherein,
each LED light string includes a plurality of LED emitters and an address signal processing device for the respective LED light string; and
the main line includes a signal bus and a power line, wherein the signal bus provides signal input for all the LED light strings, and the power line powers the LED emitters in all the LED light strings and the address signal processing devices of the respective LED light strings; and no circuit module is arranged on the main line;
the address signal processing devices arranged on the LED light strings, configured to process address signals of the plurality of LED emitters in the LED light strings, wherein,
each address signal processing device includes a processing unit,
the processing unit is configured to perform address coding on the address of at least one LED emitter in the LED light string to which the address signal processing device belongs, so as to enable the respective LED emitters in the LED light string to work normally on the premise of arranging no circuit module on the main line; or,
the processing unit does not perform address coding on the address of the LED emitter, but rather perform address coding on a signal on a signal line of each LED light string to enable the signal to correctly correspond to a corresponding LED emitter.

Preferably,
the processing unit performs address coding on addresses of a plurality of LED emitters in an LED light string in a shifting manner.

Preferably,
for the case where all LED emitters in each LED light string are connected in parallel, when some LED emitters in an LED light string fail, an address signal processing device in the LED light string is configured to perform address recoding on the addresses of all the remaining non-faulty LED emitters in the corresponding LED light string, so as to enable all the remaining non-faulty LED emitters to continue to work normally; or,
the processing unit does not perform address coding on the addresses of all the remaining non-faulty LED emitters, but performs address coding on a signal on a signal line of the LED light string in which an LED emitter failure occurs so that the signal correctly corresponds to all the remaining non-faulty LED emitters.

Preferably,
for each LED light string, at least one address signal processing device is first arranged on a position close to the main line, such that the address signal processing device first receives a signal from the signal bus of the main line via a signal line of the LED light string, then, a first LED emitter, a second LED emitter, . . . , an m-th LED emitter are arranged in sequence along an extending direction of the LED light string at positions gradually further away from the main line, wherein m is a natural number greater than 1.

Preferably,
each address signal processing device further includes a first terminal, a second terminal, and a third terminal, wherein,
the first terminal is configured to connect a signal input end of the signal bus from the main line;
the second terminal is configured to connect a “+” end of the power line from the main line; and
the third terminal is configured to connect a “−” end of the power line from the main line.

Preferably,
each LED light string includes a plurality of LED emitters, and the plurality of the LED emitters are sequentially provided with corresponding address codes.

Preferably,
for the first LED light string and the second LED light string, initial address codes are identical.

Preferably,
the first LED light string and the second LED light string are parallel light strings.

Preferably,
the address signal processing device is used for 5V-36V LED light strings.

Preferably,
for 12V-36V LED light strings, the address signal processing device includes a resistor connected with the processing unit to improve voltage withstand capability.

Preferably,
the processing unit is integrated with the first LED emitter to form a first LED emitter integrated module.

Preferably,
for any LED light string, the second LED emitter to the j-th LED emitter are configured as an independent segment of the LED light string at the factory and are configured to automatically shift a received address code, serving as a post-stage of the first LED emitter integrated module.

In summary, the present disclosure can avoid the use of signal return wires among a plurality of LED light strings and the use of a circuit module such as a decoding board on the main line, and helps to achieve fast recoding in case any LED emitter has failed and to enable the non-faulty LED emitters of each light string to work normally after recoding.

### BRIEF DESCRIPTION OF DRAWINGS

In order to illustrate the technical solutions of the embodiments of the present disclosure more clearly, the drawings required for use in the embodiments will be briefly described below. It should be understood that the following drawings only illustrate certain embodiments of the present disclosure and therefore should not be regarded as limiting the scope thereof. For those of ordinary skill in the art, other related drawings can be obtained based on these drawings without exerting creative efforts.

FIG. 1 is a schematic diagram of an address signal processing device of a curtain-type LED lamp without arranging a circuit module on a main line according to an embodiment of the present disclosure;

FIG. 2 is a schematic diagram of an address signal processing device according to another embodiment of the present disclosure; and

FIG. 3 is a schematic diagram of a first LED emitter integrated module according to another embodiment of the present disclosure.

It should be noted that the above drawings do not limit the size proportions among the lines, LED emitters, address signal processing devices, and other parts. The drawings are more intended to illustrate the structural and connection relationships, spatial positional relationships, and so on.

### DETAILED DESCRIPTION OF THE INVENTION

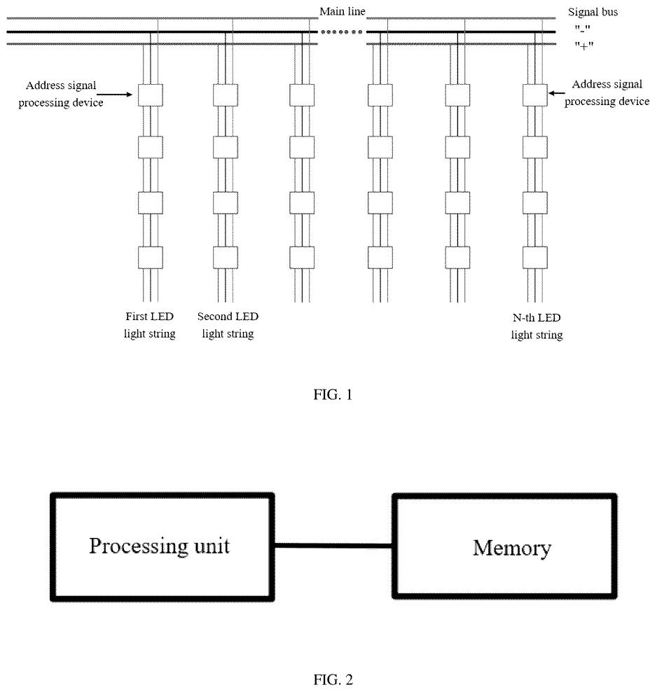

In order to make the objectives, technical solutions and advantages of the embodiments of the present disclosure more clear, the technical solutions in the embodiments of the present disclosure will be clearly and completely described below in conjunction with the accompanying drawings FIG. 1 to FIG. 3 in the embodiments of the present disclosure, and it is obvious that the described embodiments are part of the embodiments of the present disclosure, rather than all of the embodiments. The components of the embodiments of the present disclosure as generally described and illustrated in the figures herein could be arranged and designed in a wide variety of different configurations.

Thus, the following detailed description of the embodiments of the disclosure provided in the accompanying drawings is not intended to limit the scope of the claimed disclosure, but merely represents selected embodiments of the disclosure. Based on the embodiments in the present disclosure, all other embodiments obtained by those skilled in the art without creative work fall within the scope of protection of the present disclosure.

It should be noted that like reference numerals and letters represent like items in the following figures, and therefore, once an item is defined in one figure, it need not be further defined and explained in the subsequent figures.

In the description of the present disclosure, it should be noted that if the orientation or positional relationship indicated by the terms “upper”, “lower”, “inner”, “outer”, etc. is based on the orientation or positional relationship shown in the drawings, or is the orientation or positional relationship usually placed when the product of the present disclosure is used, it is only for convenience and simplification of the description of the present disclosure, and does not indicate or imply that the referred device or element must have a specific orientation, be constructed and operated in a specific orientation, and therefore cannot be understood as a limitation of the present disclosure.

Furthermore, the appearance of the terms “first”, “second”, etc. is merely used to distinguish the description, and should not be construed as indicating or implying relative importance.

It should be noted that the features in the embodiments of the present disclosure can be combined with each other provided that there is no conflict.

Referring to FIG. 1, in one embodiment, the present disclosure provides a curtain-type LED lamp without arranging a circuit module on a main line, including:
a main line of a curtain-type LED lamp arranged in a first direction, and first to n-th (a total of n) LED light strings arranged in parallel to each other in a second direction different from the first direction to configure the curtain-type LED lamp, n being a natural number greater than 1, wherein,
each LED light string includes a plurality of LED emitters and an address signal processing device for the respective LED light string; and
the main line includes a signal bus and a power line, wherein the signal bus provides signal input for all the LED light strings, and the power line powers the LED emitters in all the LED light strings and the address signal processing devices of the respective LED light strings; and no circuit module is arranged on the main line;
the address signal processing devices arranged on the LED light strings, configured to process address signals of the plurality of LED emitters in the LED light strings, wherein,
each address signal processing device includes a processing unit,
the processing unit is configured to perform address coding on the address of at least one LED emitter in the LED light string to which the address signal processing device belongs, so as to enable the respective LED emitters in the LED light string to work normally on the premise of arranging no circuit module on the main line; or,
the processing unit does not perform address coding on the address of the LED emitter, but rather perform address coding on a signal on a signal line of each LED light string to enable the signal to correctly correspond to a corresponding LED emitter.

It can be understood that the above embodiments are based on the correspondence between addresses and LED light emitters to enable the processing unit to flexibly choose between two coding methods. Regardless of which approach is used, they both involve address coding and do not involve the processing of data signals related to how LED emitters emit light in different colors. This is because, regardless of the approach taken, the ultimate goal is to drive the LED emitters at the correct addresses, and there is no involvement in modifying their data signals in a narrow sense. The fundamental reason is that since there is a correspondence between the signals transmitted on the signal lines and the LED emitters, the processing unit can not only code the addresses of the LED emitters but can also choose not to perform address coding on the LED emitters. Instead, it can perform address coding on the signal on the signal line of each LED light string to enable the signal to correctly correspond to a corresponding LED emitter.

In another embodiment,
any two LED light strings are parallel light strings.

In another embodiment,
the address signal processing device is used for 5V-36V LED light strings.

In another embodiment,
for 12V-36V LED light strings, the address signal processing device includes a resistor connected with the processing unit to improve voltage withstand capability.

In another embodiment,
the curtain-type LED lamp can operate at 110V-230V and only needs to have a corresponding AC/DC module.

It can be appreciated that the present disclosure is not limited to voltages such as 110V, 230V, etc., it can apply to other power supply voltage standards or even a wider voltage range.

Referring to FIG. 2, in another embodiment,
the address signal processing device further includes a memory for storing parameters for the processing unit to recall, so that the processing unit can perform address coding on the address of the at least one LED emitter, or perform coding on the signal on the signal line of each LED light string.

In another embodiment,
the processing unit performs address coding on the address of the at least one LED emitter in a shifting manner, or performs coding on the signal on the signal line of each LED light string. For further embodiments related to shifting, please refer to the subsequent text.

For the above-mentioned embodiment, when it is applied to the curtain-type LED lamp, the address signal processing device only needs to be arranged on each LED light string of the curtain-type LED lamp, without the need to specifically arrange a decoding board on the main line as in the prior art. This not only eliminates the need for a decoding board but also allows the elimination of signal return wires between different LED light strings for transmitting a unified address signal (Note: this is also the reason why FIG. 1 does not involve any signal return wires). When any LED light string fails, for example, if an LED emitter in the light string is damaged and cannot emit light, the present disclosure can still perform address coding on each LED emitter in all LED light strings through the processing unit in a shifting manner. It is only necessary to ensure that within each LED light string, the addresses of the normal LED emitters are recoded in a shifting manner to avoid conflicts between them. For instance, the addresses of the LED emitters in the post-stage LED light string (e.g., the second LED light string) can be coded by the address signal processing device in the post-stage LED light string based on the address coding of the preceding-stage LED light string (the first LED light string) according to the same rule in a shifting manner. This ensures that there are no two LED emitters with exactly the same address in the entire curtain-type LED lamp. In this way, there is no need to arrange a decoding board on the main line to uniformly and once-for-all code all the addresses of all LED emitters in all LED light strings according to a certain rule.

Thus, the present disclosure facilitates recoding of addresses in case any LED emitter has failed. For example, it only requires removing the faulty LED emitter and then utilizing the address signal processing device to perform address coding on the addresses of all remaining non-faulty LED emitters in the corresponding LED light string.

In another embodiment,
for the case where all LED emitters in each LED light string are connected in parallel, when some LED emitters in an LED light string fail, the address signal processing device in the LED light string is configured to perform address coding on the addresses of all the remaining non-faulty LED emitters in the corresponding LED light string, so as to enable all the remaining non-faulty LED emitters to continue to work normally; or,
the processing unit does not perform address coding on the addresses of all the remaining non-faulty LED emitters, but performs address coding on a signal on a signal line of the LED light string in which an LED emitter failure occurs so that the signal correctly corresponds to all the remaining non-faulty LED emitters.

In another embodiment,
for each LED light string, at least one address signal processing device is first arranged on a position close to the main line, such that the address signal processing device first receives a signal from the signal bus of the main line via a signal line of the LED light string, then, a first LED emitter, a second LED emitter, . . . , an m-th LED emitter are arranged in sequence along an extending direction of the LED light string at positions gradually further away from the main line, wherein m is a natural number greater than 1.

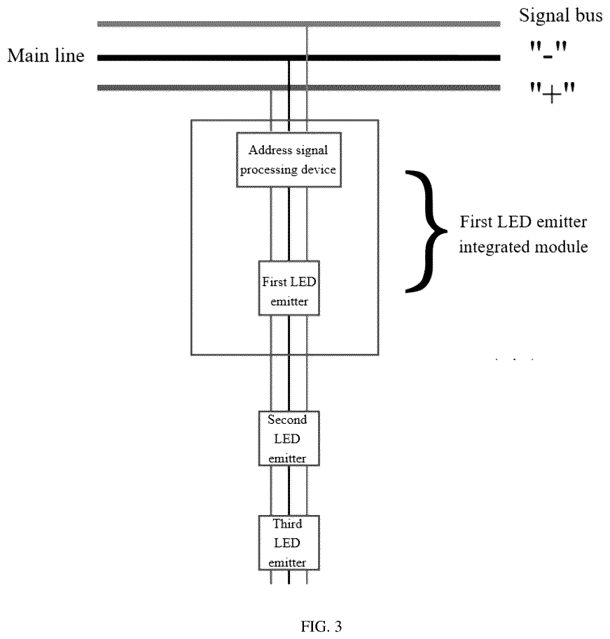

Further referring to FIG. 3, when any LED light string is connected with the main line, the first LED emitter is integrated with the address signal processing device to form a first LED emitter integrated module. Then, the first LED emitter integrated module is sequentially connected with the second LED emitter, the third LED emitter, and so on, along the LED light string. Wherein, the first LED emitter, the address signal processing device, the second LED emitter, the third LED emitter, etc., are all connected in parallel through “+” and “−” power lines, and then the signal bus is connected with the LED light string. Via the signal bus, the address signal processing device, the first LED emitter, the second LED emitter, the third LED emitter, . . . , and the j-th LED emitter are sequentially connected in series.
for the first LED light string, second LED light string, . . . , and n-th LED light string shown in FIG. 1, when all LED light strings are manufactured, it is assumed that each LED light string includes 20 LED emitters, and the addresses of these 20 LED emitters are all defaulted to a factory setting of 1-20. Then, when the plurality of LED light strings and their respective address signal processing devices are assembled into an LED lamp, such as a curtain-type LED lamp:
since the first address signal processing device belonging to the first LED light string is responsible for the first LED light string, and there is no preceding-stage LED light string before the first LED light string, let i represent the i-th LED light string, and at this point, i is 1, the address of the first address signal processing device of the first LED light string can be set to be i−1 (Note: this address is stored in the memory of the signal processing device). At this point, i−1 equals 0, and which can be interpreted as: the address signal processing device connects to the signal input from the signal bus on the main line, but the signal bus on the main line does not transmit any specific address signal, and there is no preceding-stage address signal processing device for the first address signal processing device. Considering that there are 20 LED emitters in the first LED light string, the first address signal processing device performs a shifting operation starting from 0 on these 20 LED emitters and codes their addresses as 1-20;
since the second address signal processing device belonging to the second LED light string follows the 20 LED emitters of the first LED light string, the first signal terminal of the second address signal processing device is connected with the signal input terminal of the preceding-stage address signal processing device (i.e., the first address signal processing device transmits the information of “20” to the first signal terminal of the second address signal processing device). Because of this, in the second address signal processing device of the second LED light string, its memory stores its own address as 20. Consequently, the addresses of all the LED emitters in the second LED light string will continue from the last LED emitter's address in the first LED light string and be recoded sequentially as 21-40, and so on in the same manner;
wherein,
the address signal processing device can be further equipped with an coding switch or button, such that each press of the switch or button allows the processor to sequentially code all LED emitters in electrical connection in the current LED light string in a shifting manner. Or, the address signal processing device can further be externally connected with a coder to realize the address coding function of the address signal processing device disclosed in this disclosure:
for example, for m functional LED emitters electrically connected in the first LED light string, they are directly coded from 1 to m, wherein m is less than or equal to max, and max represents the maximum number of LED emitters in each LED light string;
it can be understood that the maximum number of LED emitters max in each LED light string can be preset in the memory of the address signal processing device or can be set by maintenance personnel on-site. Further, considering the first LED light string mentioned earlier, when it has 20 LED emitters, max can be set to be 20 either at the factory or on-site;
to be broad, for the m functional LED emitters electrically connected within the i-th LED light string, coding starts directly from (i−1)*m+1 and proceeds to i*m. To facilitate understanding of this calculation method, for example, for the address signal processing device of the first LED light string, i.e., the first signal processing device, since i represents the i-th LED light string, in this case, i is 1, thus i−1 equals 0. Then, it is assumed that m=max=20, the first LED light string has 20 functional LED emitters. The first address signal processing device performs a shifting operation starting from 0 for the 20 LED emitters in the first LED light string, thereby coding the address of each LED emitter. The coding starts from (i−1)*m+1, which is 1, and proceeds in a shifting manner to i*m, which is 20;
further, when i is equal to 2, m=max=20, i.e. 20 functional LED emitters are electrically connected in the second LED light string, then the address signal processing device of the second LED light string codes all the 20 functional LED emitters in the second LED light string, coding starts from (i−1)*m+1, i.e. 21, and proceeds to i*m, i.e. 40, in a shifting manner; preferably, each of the i, j, max, m, etc. may be provided on-site in the memory of the address signal processing device.

Thus, in another embodiment,
the address of the address signal processing device is preset.

Further, in another embodiment,
for the first LED light string and the second LED light string, initial address codes are identical.

To be broad, any two LED light strings are initially coded from 1, and coded up to max. This means that the address for each LED string can be made the same. It only needs to be re-coded by the address signal processing device of that LED light string during use.

It should be noted that for the various embodiments disclosed in this disclosure, an innovative solution is: through the address signal processing device, address coding is performed on the address of the first LED emitter in its associated LED light string, and in conjunction with the second LED emitter to the j-th LED emitter that can automatically shift the received address code, it is also possible to realize a curtain-type LED lamp without arranging the circuit module (such as the decoding board, etc.) on the main line, while ensuring that all LED emitters in the LED light string function normally. For example, in another embodiment, as shown in FIG. 3, for the i-th LED light string, along the extension direction of the LED light string, an address signal processing device, a first LED emitter, a second LED emitter, . . . , and an m-th LED emitter are sequentially arranged on the LED light string, wherein the m LED emitters are capable of functioning normally, and m is a natural number greater than 1, and
the address signal processing device, the first LED emitter, the second LED emitter, . . . , and the j-th LED emitter are all connected in parallel via the “+” and “−” power lines in the LED light string, wherein the “+” and “−” power lines of the address signal processing device are connected to the “+” and “−” power lines of the main line, and
the address signal processing device, the first LED emitter, the second LED emitter, . . . , and the j-th LED emitter are all connected in series via the signal line in the LED light string, wherein the signal line of the address signal processing device is connected with the signal bus of the main line;
wherein,
the second LED emitter to the j-th LED emitter are capable of automatically shifting the received address code;
the method of operation of the LED light string includes the steps of:
S100: the address signal processing device codes the address of the first LED emitter in advance; wherein the address code is: (−1)*m+1, see in particular the above examples where i is 1 or i is 2;
S200: the address signal processing device receives a control signal from the signal bus in the main line, and outputs a first mixed signal containing the address code (i−1)*m+1 and the control signal;
S300: the first LED emitter receives the first mixed signal, and according to the resolved address code (i−1)*m+1, acquires a first control signal which is a portion of the control signal and is specifically dedicated to controlling the first LED emitter to emit light, and outputs a second mixed signal consisting of a first remaining control signal other than the first control signal in the control signal and the address code (i−1)*m+1;
S400: the second LED emitter receives the second mixed signal, and performs auto-shifting according to the parsed address code (i−1)*m+1 to obtain an auto-shifted address code (i−1)*m+2, further acquires a second control signal, which is a portion of the first remaining control signal and is specifically dedicated to controlling the second LED emitter to emit light, and outputs a third mixed signal consisting of the second remaining control signal other than the second control signal in the first remaining control signal and the address code (i−1)*m+2; and
S500: the third LED emitter receives the third mixed signal, and performs auto-shifting according to the parsed address code (i−1)*m+2 to obtain an auto-shifted address code (i−1)*m+3, further acquires a third control signal, which is a portion of the second remaining control signal and is specifically dedicated to controlling the third LED emitter to emit light, and outputs a fourth mixed signal consisting of the third remaining control signal other than the third control signal in the second remaining control signal and the address code (i−1)*m+3.

Similarly, the present disclosure performs address coding only on the address of the first LED emitter, and, in conjunction with the second LED emitter to the j-th LED emitter capable of automatically shifting the received address code, achieves the curtain-type LED lamp without arranging the circuit module (such as a decoding board, etc.) on the main line, and make the individual LED emitter in the LED light string work normally.

For the above embodiment, the address signal processing device is configured to perform address coding on the address of the first LED emitter. It is to be noted that for any LED light string, when the address signal processing device and the first LED emitter is integrated into the first LED emitter integrated module, the second LED emitter to the j-th LED emitter are configured as an independent segment of the LED light string at the factory and are configured to automatically shift a received address code, serving as a post-stage of the first LED emitter integrated module. However, the address signal processing device and the first LED emitter do not have to be integrated together, and the two may not be integrated at all, as long as the following conditions are still satisfied: the address signal processing device is configured to perform address coding on the address of the first LED emitter; also because the second to j-th LED emitters can be configured as an independent segment of the LED light string at the factory, and are configured to automatically shift a received address code. Therefore, one only needs to connect the first LED emitter integration module and the corresponding segment of LED light string to the main line in sequence, or connect the non-integrated address signal processing device, the first LED emitter, and the corresponding segment of LED light string to the main line in sequence.

It can be understood that a more general solution, compared to the aforementioned embodiment, would be as follows: by using the address signal processing device to perform address coding on the addresses of all LED emitters in its respective LED light string, it is certainly possible to achieve a curtain-type LED lamp without arranging a circuit module (such as a decoder board, etc.) on a main line, while ensuring that each LED emitter in the LED light string operates normally.

The above is only specific embodiments of the present disclosure, but the protection scope of the present disclosure is not limited thereto, and any variations or substitutions easily conceivable by those skilled in the art within the technical scope of the present disclosure should be covered by the protection scope of the present disclosure. Therefore, the protection scope of the present disclosure should be subject to the protection scope of the claims.

1. A curtain-type LED lamp without arranging a circuit module on a main line, comprising:
a main line of a curtain-type LED lamp arranged in a first direction, and first to n-th (a total of n) LED light strings arranged in parallel to each other in a second direction different from the first direction to configure the curtain-type LED lamp, n being a natural number greater than 1, wherein, each LED light string comprises a plurality of LED emitters and an address signal processing device for the respective LED light string; and
the main line comprises a signal bus and a power line, wherein the signal bus provides signal input for all the LED light strings, and the power line powers the LED emitters in all the LED light strings and the address signal processing devices of the respective LED light strings; and no circuit module is arranged on the main line;
the address signal processing devices arranged on the LED light strings, configured to process address signals of the plurality of LED emitters in the LED light strings, wherein, each address signal processing device comprises a processing unit,
the processing unit is configured to perform address coding on the address of at least one LED emitter in the LED light string to which the address signal processing device belongs, so as to enable the respective LED emitters in the LED light string to work normally on the premise of arranging no circuit module on the main line; or,
the processing unit does not perform address coding on the address of the LED emitter, but rather perform address coding on a signal on a signal line of each LED light string to enable the signal to correctly correspond to a corresponding LED emitter.

2. The curtain-type LED lamp according to claim 1, wherein, the processing unit performs address coding on addresses of a plurality of LED emitters in an LED light string in a shifting manner.

3. The curtain-type LED lamp according to claim 1, wherein, for the case where all LED emitters in each LED light string are connected in parallel, when some LED emitters in an LED light string fail, an address signal processing device in the LED light string is configured to perform address recoding on the addresses of all the remaining non-faulty LED emitters in the corresponding LED light string, so as to enable all the remaining non-faulty LED emitters to continue to work normally; or,
the processing unit does not perform address coding on the addresses of all the remaining non-faulty LED emitters, but performs address coding on a signal on a signal line of the LED light string in which an LED emitter failure occurs so that the signal correctly corresponds to all the remaining non-faulty LED emitters.

4. The curtain-type LED lamp according to claim 1, wherein, for each LED light string, at least one address signal processing device is first arranged on a position close to the main line, such that the address signal processing device first receives a signal from the signal bus of the main line via a signal line of the LED light string, then, a first LED emitter, a second LED emitter, . . . , an m-th LED emitter are arranged in sequence along an extending direction of the LED light string at positions gradually further away from the main line, wherein m is a natural number greater than 1.

5. The curtain-type LED lamp according to claim 1, wherein, each LED light string comprises a plurality of LED emitters, and the plurality of the LED emitters are sequentially provided with corresponding address codes.

6. The curtain-type LED lamp according to claim 1, wherein, for the first LED light string and the second LED light string, initial address codes are identical.

7. The curtain-type LED lamp according to claim 1, wherein, the address signal processing device is used for 5V-36V LED light strings.

8. The curtain-type LED lamp according to claim 11, wherein, for 12V-36V LED light strings, the address signal processing device comprises a resistor connected with the processing unit to improve voltage withstand capability.

9. The curtain-type LED lamp according to claim 1, wherein, the processing unit is integrated with the first LED emitter to form a first LED emitter integrated module.

10. The curtain-type LED lamp according to claim 9, wherein, for any LED light string, the second LED emitter to the j-th LED emitter are configured as an independent segment of the LED light string at the factory and are configured to automatically shift a received address code, serving as a post-stage of the first LED emitter integrated module.
